(19) United States
(12) Patent Application Publication
(10) Pub. No.: US 2014/0190975 A1
(43) Pub. Date: Jul. 10, 2014

(54) Combination baking sheet and cooling rack

(71) Applicants: Chris Roylance, Tucson, AZ (US); Jared Morse, Lindon, UT (US)

(72) Inventors: Chris Roylance, Tucson, AZ (US); Jared Morse, Lindon, UT (US)

(21) Appl. No.: 14/148,871

(22) Filed: Jan. 7, 2014

Related U.S. Application Data
(60) Provisional application No. 61/749,621, filed on Jan. 7, 2013.

(51) Int. Cl. A47J 27/00

(52) U.S. Cl. CPC A47J 27/002
USPC 220/573.1

(57) ABSTRACT

A device will incorporate a baking sheet with an attached cooling rack. The user places the cooling rack onto the provided grooves in the baking sheet using the cooling rack's fixed handles, creating a flush surface, before placing food items to be baked onto the baking sheet. After baking, the device is taken out of the oven and the cooling rack is removed from the baking sheet, using the fixed handles. The provided rotating handles are rotated outward and folded under the cooling rack, forming a pair of legs. The cooling rack is then placed on a counter, table, or other flat surface, with the legs preferably resting on the level surface.

### CROSS-REFERENCE TO RELATED APPLICATIONS

This application claims the benefit of U.S. Provisional Application No. 61749621, filed Jan. 7, 2013, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to cooling racks for freshly baked foods, and in particular to a combined baking sheet and cooling rack for freshly baked foods. Users who bake multiple small food items such as cookies, biscuits and dinner rolls find transferring the food items to a cooling rack after baking to be tedious, time consuming and tiresome. A combined baking sheet and cooling rack would eliminate this time consuming step and make baking more enjoyable.

### SUMMARY OF THE INVENTION

Accordingly, the invention is directed to a device that will incorporate a baking sheet with attached cooling rack. The user places the cooling rack onto the provided grooves in the baking sheet using the cooling rack's fixed handles, creating a flush surface, before placing food items to be baked onto the baking sheet. After baking, the device is taken out of the oven and the cooling rack is removed from the baking sheet, using the fixed handles. The provided rotating handles are rotated outward and folded under the cooling rack, forming a pair of legs. The cooling rack is then placed on a counter, table, or other flat surface, with the legs preferably resting on the level surface.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1A shows the cut-away side view of the first exemplary embodiment displaying the baking sheet 10 and the grooves 14.

FIG. 1B shows the cut-away front view of the first exemplary embodiment displaying the baking sheet 10 and the grooves 14.

FIG. 1C shows a side view of the first exemplary embodiment displaying the baking sheet 10, the cooling rack 11, the fixed handle 12, and the rotating handle 13 in storage mode.

FIG. 2 shows the top view of the first exemplary embodiment displaying the cooling rack 11, the fixed handles 12, and the rotating handles 13.

FIGS. 3A-3E show the side view of the first exemplary embodiment displaying the rotating handles 13 being rotated outward and under the baking sheet 10 and the cooling rack 11. The fixed handles 12 and rack supports 15 are also shown.

FIG. 4 shows an elevated perspective view of the second exemplary embodiment with the cooling rack 41 separated from the baking sheet 40 and placed in an elevated position, displaying the fixed handles 42, rotating handles 43, grooves 44, and rack supports 45.

FIG. 5 shows an elevated perspective view of the second exemplary embodiment with the cooling rack 41 fitted within the baking sheet 40 with the rack supports 45 fitting complementarily within the grooves 44, and also displaying the fixed handles 42, rotating handles 43, grooves 44, and rack supports 45.

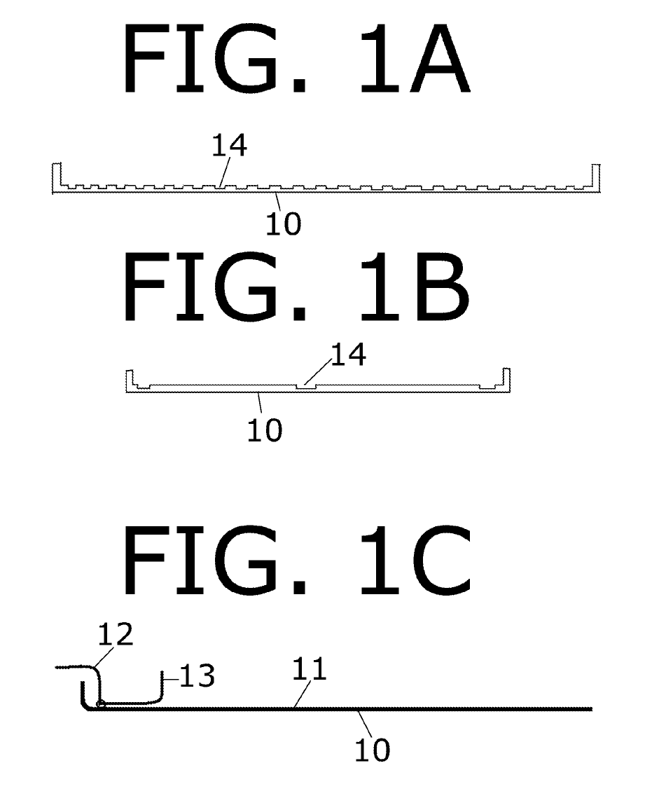

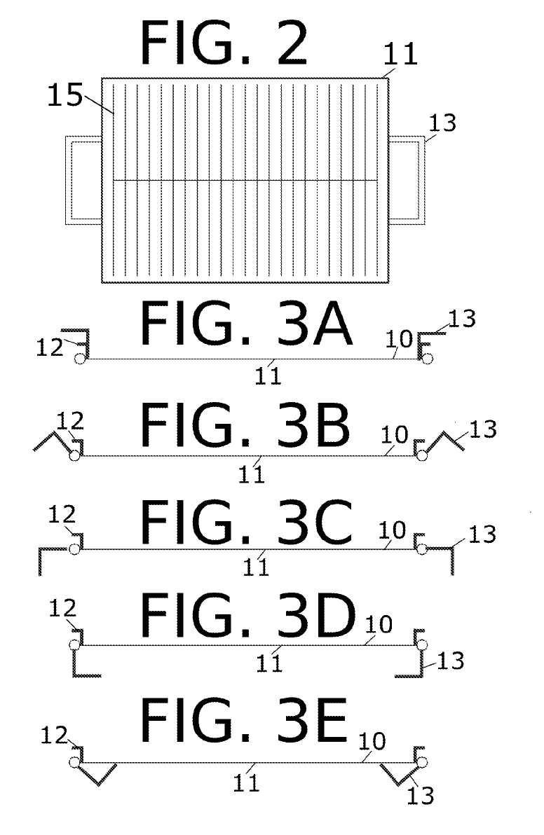

### DETAILED DESCRIPTION OF THE INVENTION

Referring now to the invention in more detail, the invention is directed to a device that will incorporate a baking sheet 10 with attached cooling rack 11. The cooling rack 11 is inset into the baking sheet 10 and the user places the cooling rack 11 onto the baking sheet 10 using the fixed handles 12. The rack is composed of a plurality of rack supports 15, which fit complementarily into grooves 14 inlaid into the surface of the baking sheet 10, creating a flush surface. When the cooling rack 11 and baking sheet 10 are so fitted, the rotating handles 13 are rotated up into a storage position and food items may be placed on the flush surface for baking. Optionally, the 14 may be made shallow or non-existent and the rack supports 15 made thin such that the surface remains substantially flush, even while the rack supports 15 are elevated somewhat relative to the baking sheet 10.

After the baking process is complete, the device is taken out of the oven, and the cooling rack 11 is removed from the baking sheet 10 using the fixed handles 12. The fixed handles 12 remain in place while the folding handles 13 are rotated outward and folded under the cooling rack 11, forming a pair of legs. The cooling rack 11 is then placed on a counter, table, or other flat surface, with the folding handles 13 preferably resting on the level surface. The fixed handles 12 and rotating handles 13, are preferably comprised of a heat resistant material, allowing the device to be safely placed on any level surface. The device is comprised of rigid, durable material such as steel, aluminum, or similar materials. Nonstick surfaces, such as Teflon, are also contemplated as part of the basic device components.

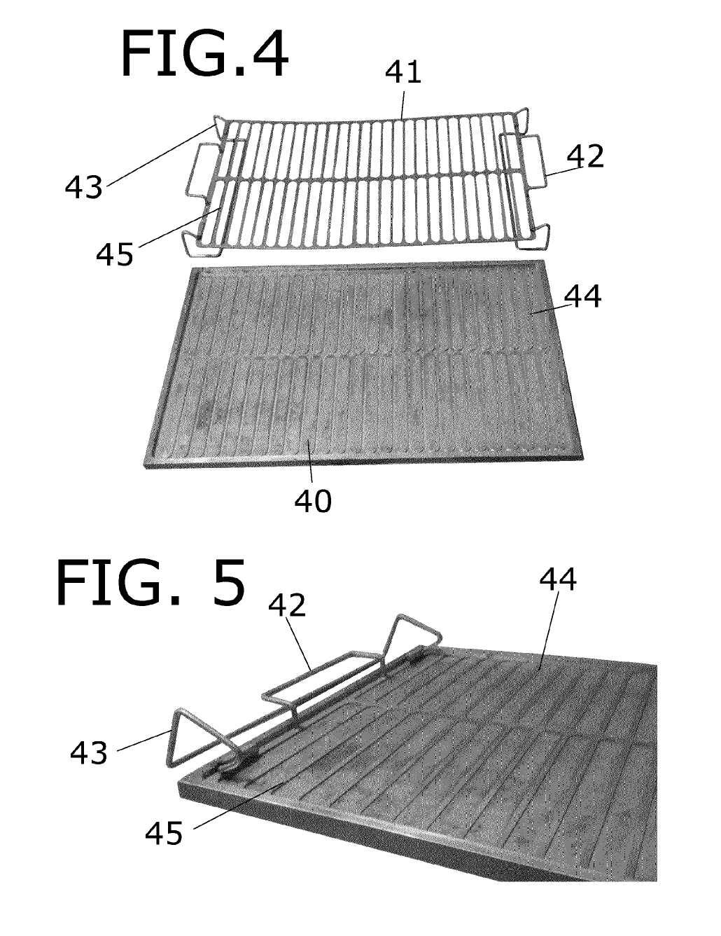

FIGS. 4-5 shows the second exemplary embodiment. Analogously to the first exemplary embodiment, a backing sheet 40 is structured with grooves 44, which are complementary in shape to the rack supports 45 of a cooling rack 41. The cooling rack 41 is fixedly attached to a pair of fixed handles 42 and rotatably attached to a pair of rotatable handles 43. The rotatable handles 43 may be rotated up into a storage position when the baking sheet 40 and cooling rack 41 are fitted together as show in FIG. 5, or may be rotated under the cooling rack 41 to form support legs as shown in FIG. 4.

A standard size device would preferably be fifteen inches long and ten inches wide. Other device sizes are contemplated, such as a twenty-six inches long and eighteen inches wide device, with a fourteen inch handle 13, for users in a commercial kitchen Further device sizes that are contemplated are eighteen inches long and thirteen inches wide with a nine inch handles 13; and devices that are thirteen inches long and nine inches wide with a seven inch handle 13. Additional device sizes are also contemplated.

Component sizes listed above are preferable, but artisans will recognize that larger or smaller component sizes could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the overhead described embodiment, method, and examples, but by all embodiments and methods within the scope and spirit of the invention.

We claim:

1. A combined baking sheet and cooling rack comprising:
(a) a cooling rack;
(b) said cooling rack being composed of a plurality of rack supports;
(c) a baking sheet;
(d) said cooling rack being of a size and shape to fit complementarily into said baking sheet;
(e) the combination of said cooling rack and said baking sheet being fitted complementarily together having a substantially flush surface.

2. The combined baking sheet and cooling rack of claim 1 wherein said baking sheet is shaped so as to have a plurality of grooves, said grooves being complementary in shape to said rack supports such that said rack supports fit into said grooves.

3. The combined baking sheet and cooling rack of claim 1 wherein said cooling rack has, rigidly affixed thereto, a plurality of fixed handles.

4. The combined baking sheet and cooling rack of claim 1 wherein said cooling rack has, rotatably affixed thereto, a plurality of rotatable handles such that said rotatable handles may be moved between a storage position and support position, whereby said rotatable handles may be stored in said storage position while said cooling rack is fitted complementarily to said baking sheet, and said rotatable handles may elevate said cooling rack while in said support position.

5. The combined baking sheet and cooling rack of claim 2 wherein said cooling rack has, rigidly affixed thereto, a plurality of fixed handles.

6. The combined baking sheet and cooling rack of claim 4 wherein said cooling rack has, rigidly affixed thereto, a plurality of fixed handles.

7. The combined baking sheet and cooling rack of claim 2 wherein said cooling rack has, rotatably affixed thereto, a plurality of rotatable handles such that said rotatable handles may be moved between a storage position and support position, whereby said rotatable handles may be stored in said storage position while said cooling rack is fitted complementarily to said baking sheet, and said rotatable handles may elevate said cooling rack while in said support position.

8. The combined baking sheet and cooling rack of claim 5 wherein said cooling rack has, rotatably affixed thereto, a plurality of rotatable handles such that said rotatable handles may be moved between a storage position and support position, whereby said rotatable handles may be stored in said storage position while said cooling rack is fitted complementarily to said baking sheet, and said rotatable handles may elevate said cooling rack while in said support position.
